(19) United States
(12) Patent Application Publication
(10) Pub. No.: US 2007/0187920 A1
(43) Pub. Date: Aug. 16, 2007

(54) Rear suspension assembly

(75) Inventor: Christopher K. Furman, Augusta, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/355,374

(22) Filed: Feb. 16, 2006

(51) Int. Cl. B60G 11/00; B23P 21/00

(52) U.S. Cl. 280/124.175; 29/784; 280/124.17

(57) ABSTRACT

A method for standardizing fastener installation for a golf car suspension system includes configuring each of a plurality of suspension system component connections as a metal-to-metal contact connection. The method further includes selecting a single fastener engagement size for each of a plurality of fasteners used to couple the component connections. Further, the method includes applying a predetermined torque to the plurality of fasteners, the predetermined torque selected from a predetermined range of torque values. Still further, the method includes installing each of the fasteners using a single installation tool.

### FIELD

The present disclosure relates to methods for connecting suspension and drive train elements for golf car and off-road utility vehicles.

### BACKGROUND

The statements in this section merely provide background information related to the present disclosure and may not constitute prior art.

Golf cars and many off-road or utility vehicles, hereinafter “golf cars” commonly have suspension systems requiring multiple components and multiple fasteners for installation. Assembly line construction of golf cars commonly requires multiple installation tools and multiple different supplies of fasteners be present. This can lead to installation of incorrectly sized fasteners or application of insufficient or excessive torque to the fasteners if the wrong fastener or incorrect torque tool is used.

Assembly costs of common golf car designs are therefore limited in part by the quantity of fastener types and torques to be used. Further, visual inspection is often unable to determine if incorrect fasteners or torques are used, leading to potential deficiencies. Use of installation dollies or fixtures to hold components during assembly is also potentially limited due to different access requirements for different sized installation tools.

### SUMMARY

According to several embodiments of the present disclosure, a method for standardizing fastener installation for a golf car suspension system includes configuring each of a plurality of suspension system component connections as a metal-to-metal contact connection. The method further includes selecting a single fastener engagement size for each of a plurality of fasteners used to couple the component connections. Further, the method includes applying a predetermined torque to the plurality of fasteners, the predetermined torque selected from a predetermined range of torque values. Still further, the method includes installing each of the fasteners using a single installation tool.

According to other embodiments, a method for standardizing fastener installation for a golf car suspension system, the suspension system including a leaf spring and a shock absorber includes configuring each of a plurality of suspension system component connections as one of a plurality of metal-to-metal contact connections. The method also includes selecting a single fastener engagement size for each of a plurality of fasteners used to couple the plurality of component connections. The method further includes sub-assembling the plurality of suspension system component connections prior to torquing any of the plurality of fasteners. The method still further includes applying a single predetermined torque value to each of the plurality of fasteners, the predetermined torque value selected from a range of torque values.

According to still other embodiments, a method for assembling a golf car suspension system, the suspension system having a shoulder bolt having a bolt head, a bolt having a bolt shaft, a leaf spring having a rolled end, a leaf spring link assembly, a shock absorber having a connecting sleeve and an extension sleeve positioned within the connecting sleeve, and a support plate includes installing a plurality of fasteners to operably assemble the golf car suspension system. The method also includes sliding a first fastener defining the shoulder bolt having a starting thread position through the rolled end of the leaf spring. The method further includes connecting a second fastener defining a first nut into engagement with the starting thread position to operably define a first metal-to-metal contact connection. The method still further includes positioning a third fastener defining the bolt with the bolt shaft inserted through the extension sleeve until a bolt engagement face of the bolt contacts a first end of the extension sleeve. The method yet still further includes engaging a second end of the extension sleeve with a frame member to operably create a second metal-to-metal contact connection. The method thereafter includes applying a torque having a single torque value to each of the plurality of fasteners.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a golf car having the rear suspension assembly according to various embodiments of the present disclosure;

FIG. 2 is a bottom plan view of the golf car of FIG. 1;

FIG. 3 is a perspective view of an assembly including a rear suspension assembly of the present disclosure;

FIG. 4 is a bottom plan view of the assembly of FIG. 3;

FIG. 5 is a partial cross sectional view taken at section 5-5 of FIG. 3; and

FIG. 6 is a cross sectional view taken at section 6-6 of FIG. 3.

### DETAILED DESCRIPTION

The following description is merely exemplary in nature and is in no way intended to limit the present disclosure, application, or uses. Throughout this specification, like reference numerals will be used to refer to like elements. As referred to herein, the term “golf car” is synonymously used to describe application of the present disclosure to golf cars as well as sport utility vehicles such as modified golf cars, used for example as food and/or beverage cars, golf cars adapted for use as hunting/sporting clays vehicles, golf course maintenance vehicles, and the like.

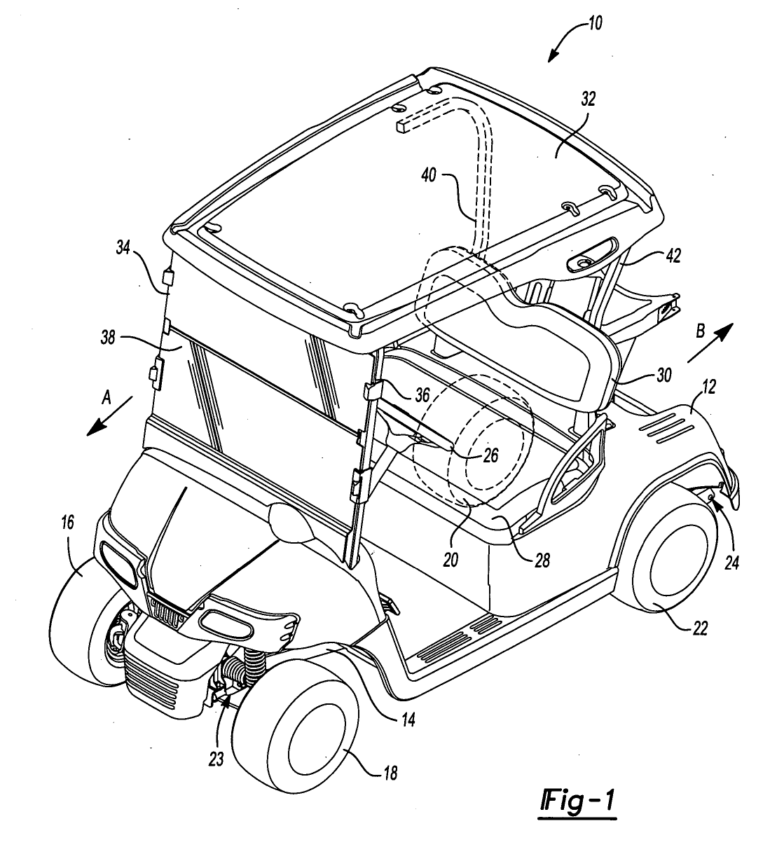

Referring generally to FIG. 1, a golf car 10 can include a body 12 supported from a structural frame 14. Frame 14 can also support a plurality of wheels including a first steerable wheel 16 and a second steerable wheel 18. In addition, powered or driven wheels including a first driven wheel 20 and a second driven wheel 22 are commonly connected to a rear structural portion of frame 14. A front suspension system 23 can also be provided which is adapted for supporting each of the first and second steerable wheels 16, 18. A rear suspension system 24 can also be provided which is adapted for supporting each of the first and second driven wheels 20, 22 from frame 14. A steering mechanism 26 which commonly includes a steering wheel and a support post assembly is also included to provide the necessary steering input to first and second steerable wheels 16, 18.

Golf car 10 can also include a passenger bench seat 28 and a passenger back support cushion 30. A cover or roof 32 can also be provided which is supported from either body 12 or frame 14 by first and second support members 34, 36. A windscreen or windshield 38 can also be provided which is also supported by each of first and second support members 34, 36. A rear section of roof 32 can be supported by each of a first and a second rear support element 40, 42. Other items provided with golf car 10 include golf bag support equipment, accessory racks or bins, headlights, side rails, fenders, and the like.

Golf car 10 is commonly propelled by a power unit such as an engine or battery/motor system which is commonly provided below and/or behind bench seat 28. Golf car 10 is capable of motion in either of a forward direction “A” or a rearward direction “B”. Each of first and second driven wheels 20, 22 can be commonly supported to frame 14 using rear suspension system 24. Each of first and second steerable wheels 16, 18 can be independently or commonly supported to frame 14, therefore the present disclosure is not limited by the design of front suspension system 23.

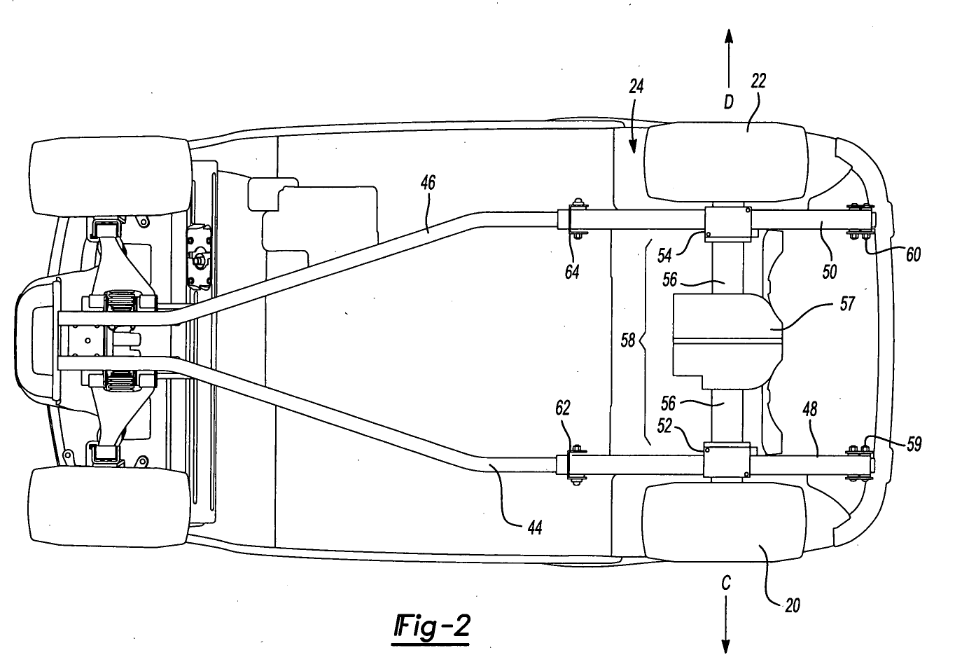

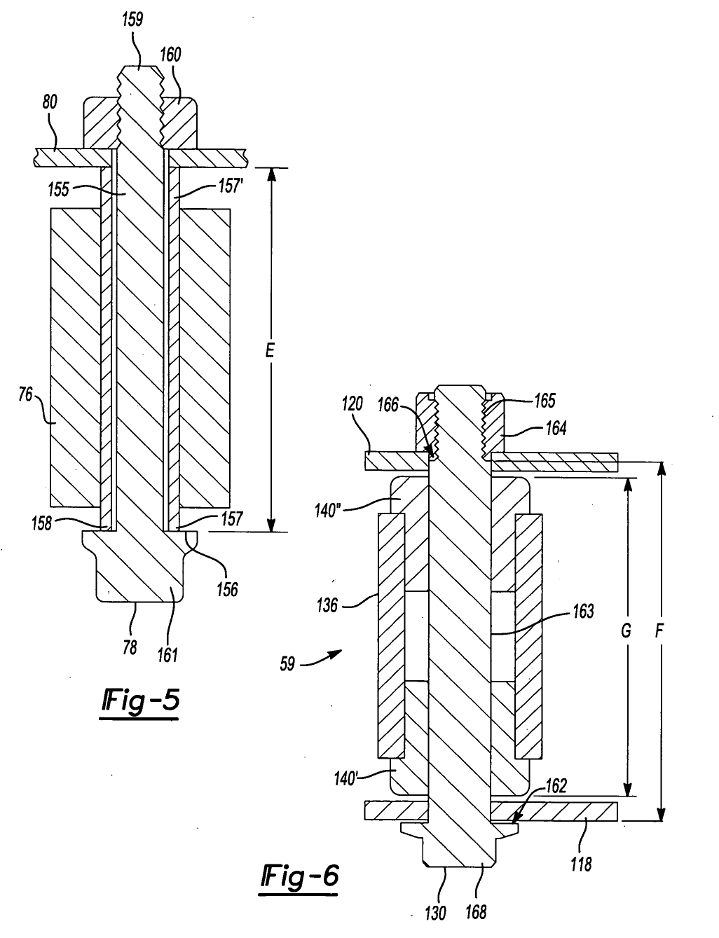

As best seen in reference to FIG. 2, frame 14 can further include a longitudinally arranged first frame member 44 and a second frame member 46. First and second frame members 44, 46 can be hollow, tubular shaped members created of a steel material or similar structural material and formed by welding, extruding, hydroforming, or similar processes. A first and second leaf spring 48, 50 support each of first and second driven wheels 20, 22. A first leaf spring/shock support assembly 52 can be connected to first leaf spring 48 and first frame member 44. Similarly, a second leaf spring/shock support assembly 54 can be connected to second leaf spring 50 and second frame member 46. Each of first and second leaf spring/shock support assemblies 52, 54 are also connected to an axle housing 56 within which an axle (shown in FIG. 5) is rotatably disposed for providing driving power to the first and second driven wheels 20, 22 through a gear train or axle gear housing 57 connected to the power unit.

First and second leaf springs 48, 50 can be connected at a rearward facing end to first and second frame members 44, 46 by each of a first and second link assembly 59, 60. In addition, first and second leaf springs 48, 50 can be connected at a forward facing end to first and second frame members 44, 46 by each of a first and second bracket assembly 62, 64. The use of first and second leaf springs 48, 50 further helps reduce deflection of the rear suspension system 24 in either of a first or second deflection direction “C” or “D”.

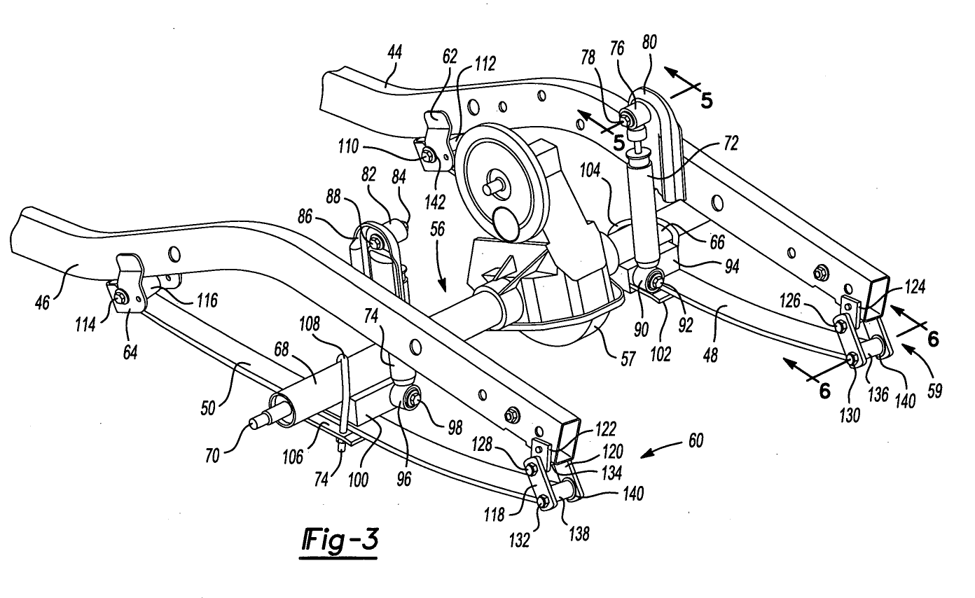

Referring now to FIG. 3, multiple components of the rear drive assembly 58 include axle gear housing 57 which divides axle housing 56 into each of a first housing portion 66 and a second housing portion 68. An axle 70 extending beyond distal ends of axle housing 56 is rotatably disposed within axle housing 56. Rotation of axle 70 by axle gear housing 57 provides the rotating drive for first and second driven wheels 20, 22.

According to several embodiments, rear suspension system 24 can further include a first shock absorber 72 and a second shock absorber 74. First shock absorber 72 can include a first connecting sleeve 76 which is fastened using a fastener 78 to a first frame extension 80. First frame extension 80 is a structural element which can be fixedly connected to first frame member 44 for example by welding. Similarly, second shock absorber 74 can include a first connecting sleeve 82 which is connected using a fastener 84 to a second frame extension 86 similar in design to first frame extension 80 but fixedly connected to second frame member 46. For installation of both first and second connecting sleeves 76, 82, a nut 88 such as a weld nut can be fixedly connected to both first and second frame extensions 80, 86 to engage fasteners 78 and 84. First shock absorber 72 can further include a second connecting sleeve 90 which is connected using a fastener 92 to first connecting member 94. Similarly, second shock absorber 74 can include a second connecting sleeve 96 connected by a fastener 98 to second connecting member 100.

First connecting member 94 can be positioned between first housing portion 66 and a first support plate 102. First leaf spring 48 is sandwiched between first support plate 102 and first connecting member 94 using a first U-shaped bolt 104. Similarly, second connecting member 100 can be positioned between second housing portion 68 and a second support plate 106. Second leaf spring 50 is sandwiched between second connecting member 100, and second support plate 106 using a second U-shaped bolt 108.

Each of the first and second leaf springs 48, 50 can be connected to respective ones of first and second frame members 44, 46 using first and second bracket assemblies 62, 64. First and second bracket assemblies 62, 64 can be welded to fixedly connect to the first or second frame member 44, 46. A first shoulder bolt fastener 110 is inserted through opposed walls of the first bracket assembly 62 and a rolled forward end 112 of first leaf spring 48. Similarly, a second shoulder bolt fastener 114 is inserted through opposed walls of the second bracket assembly 64 and a rolled forward end 116 of second leaf spring 50.

As previously noted first and second link assemblies 59, 60 connect the rear portions of first and second leaf springs 48, 50 to first and second frame members 44, 46. Each of the first and second link assemblies 59, 60 include a first shackle plate or first link 118 and a second shackle plate or second link 120, both connected to a first flange member 122 outwardly fixedly connected to first and second frame members 44, 46 and a second flange member 124 inwardly fixedly connected to first and second frame members 44, 46. A first and second shoulder bolt fastener 126, 128 are inserted through first link 118, first flange member 122, a spacing sleeve 134, and second link 120 of each of first and second link assemblies 59, 60. A third and fourth shoulder bolt fastener 130, 132 are inserted through first link 118, a rolled end 136 or 138 of first or second leaf springs 48, 50, and through second link 120. A plurality of washers/bushings 140 made of a low coefficient-of-friction polymeric material such as a polyamide material can be inserted between first or second links 118, 120 and first or second flange members 124, between first or second flange members 124 and spacing sleeves 134, or between first or second links 118, 120 and rolled ends 136, 138 to reduce friction at these locations. A nut 142 such as a weld nut, standard nut, or friction nut can be used for installation of the various shoulder bolts. For consistency, nuts used for the present disclosure are hereinafter referred to as weld nuts.

Shoulder bolts are used for shoulder bolt fasteners 110, 114, first and second shoulder bolt fasteners 126, 128, and third and fourth shoulder bolt fasteners 130, 132 for several reasons. Shoulder bolts define a pre-determined length of bolt shaft before the start of a thread end. The pre-determined length of bolt shaft fixes a spacing width of first and second bracket assemblies 62, 64 and first and second link assemblies 59, 60. The start of the thread end also defines a metal-to-metal contact connection between a nut used at the ends of these fasteners and the bolt shaft when connecting the nut to the appropriate first or second flange member 122, 124 or first or second link 118, 120. In several embodiments, an installation torque range of approximately 20 to 25 lb-ft (27.12 to 33.89 Nm) can be applied to the shoulder bolt fasteners while preventing the crushing of polymeric washers/bushings 140.

First and second leaf springs 48, 50 help limit the vertical deflection of axle housing 56. First and second shock absorbers 72, 74 dampen the vertical travel of axle housing 56 and provide a positive stop for the vertical travel. First and second connecting members 94, 100, function in part to provide an engagement area for first or second leaf springs 48, 50 to contact axle housing 56, and to provide for connection of first and second shock absorbers 72, 74.

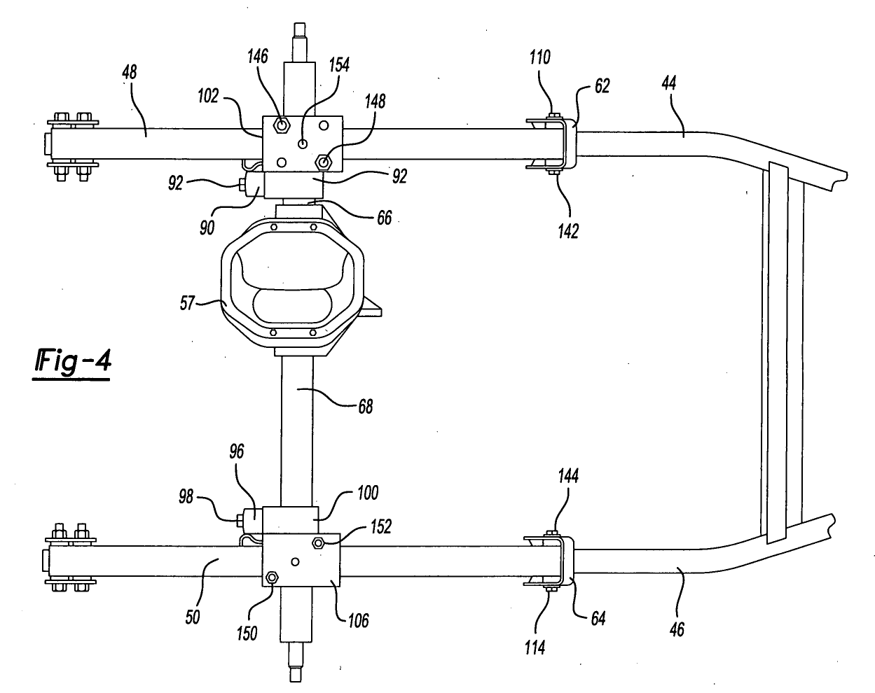

Referring now generally to FIG. 4, it will be evident that axle gear housing 57 can be positioned closer to or further from any one of the first or second leaf springs 48, 50. This affects the individual lengths of first or second housing portions 66, 68. Weld nut 142 is applied to shoulder bolt fastener 110 to couple first bracket assembly 62 to first frame member 44. A weld nut 144 is similarly applied to shoulder bolt fastener 114 to couple second bracket assembly 64 to second frame member 46. First U-shaped bolt 104 is fastened to first support plate 102 using a first and second nut 146, 148. Similarly, second U-shaped bolt 108 is fastened to second support plate 106 using a third and fourth nut 150, 152. Each of the first, second, third, and fourth nuts 146, 148, 150, and 152 create a metal-to-metal contact connection with the respective first or second support plate 102, 106. In several embodiments, these metal-to-metal contact connections permit installation of first, second, third, and fourth nuts 146, 148, 150, and 152 using an installation torque ranging from 20 to 25 lb-ft (27.12 to 33.89 Nm) inclusive. In several embodiments, a pin 154 is connected to both first and second leaf springs 48, 50 and extends through an aperture created in each of first and second support plates (toward the viewer as viewed in FIG. 4). Installation of pin 154 in the aperture fixes the orientation of rear suspension system 24 relative to frame 14. In other embodiments (not shown), pin 154 is fixed on first and second support plates 102, 106 and the corresponding aperture is disposed in first and second leaf springs 48, 50.

Referring now to FIG. 5, an exemplary installation of first connecting sleeve 76 of first shock absorber 72 to first frame extension 80 is shown. Installation of first connecting sleeve 82 of second shock absorber 74 to second frame extension 86, and both second connecting sleeves 90 and 96 of first and second shock absorbers 72, 74 to first and second connecting members 94, 100, are similar and will therefore not be further discussed. Fastener 78 such as a bolt includes a shaft 155 and an engagement face 156. Shaft 155 is inserted through a through-bore of an extension sleeve 158, and through an aperture of first frame extension 80. Shaft 155 also has a threaded end 159 which is threadably engaged by a receiving nut 160 which can be welded or otherwise fixedly connected to first frame extension 80. A fastener head 161 can be configured for example in a hexagonal or similar geometric shape or provided with a similarly shaped female key receiving slot as known. A length “E” of extension sleeve 158 is predetermined to create clearance for first connecting sleeve 76 and to define a metal-to-metal contact connection between engagement face 156, extension sleeve 158, and first frame extension 80. This metal-to-metal contact connection prevents first connecting sleeve 76 from being frictionally or non-rotationally bound between engagement face 156 and first frame extension 80. A length of first connecting sleeve 76 is less than length “E” therefore free rotation of first connecting sleeve 76 about extension sleeve 158 is permitted. Because of the metal-to-metal contact connections provided at first and second ends 157, 157′ of extension sleeve 158, fastener 78 can be torqued to a torque value ranging between and inclusive of 20 to 25 lb-ft (27.12 to 33.89 Nm).

Referring now to FIG. 6, an exemplary installation of first link assembly 59 is shown. Installation of second link assembly 60 is substantially identical, and will therefore not be further discussed herein. Third shoulder bolt fastener 130 includes a head engagement face 162 and a shaft 163. Head engagement face 162 contacts first link 118 when shaft 163 is disposed through an aperture of first link 118, an aperture of a first washer/bushing 140′, a through-aperture of rolled end 136 of first leaf spring 48, an aperture of a second washer/bushing 140″, an aperture of second link 120, and is threadably received by a weld nut 164 similar to weld nut 142. A threaded end 165 of shaft 163 is defined from a starting thread position 166. A fastener head 168 can be configured for example in a hexagonal or similar geometric shape or provided with a similarly shaped female key receiving slot. Starting thread position 166 in contact with weld nut 164, which is also in contact with second link 120, define a metal-to-metal contact position or connection between second link 120, nut 164 and shaft 163 when head engagement face 162 contacts first link 118. A shaft length “F” is therefore predetermined based on a width “G” of rolled end 136 of first leaf spring 48 plus a free extending thickness of both first and second washer/bushings 140′, 140″ beyond first leaf spring 48. A metal-to-metal contact connection between nut 164 and shaft 163 will therefore occur before first or second washer/bushings 140′, 140″, which are created of a resilient polymeric material, will yield or crush. Because of the metal-to-metal contact connection provided between nut 164 and shaft 163, third shoulder bolt fastener 130 can be torqued to a torque value ranging between and inclusive of 20 to 25 lb-ft (27.12 to 33.89 Nm).

Referring back to FIG. 3, the installation of first and second shoulder bolt fasteners 110, 114 is similar to the installation described in reference to FIG. 6, having rolled ends 136, 138 and first and second links 118, 120 replaced by rolled forward ends 112, 116 and the walls of first and second bracket assemblies 62, 64. The installation first and second shoulder bolt fasteners 126, 128 is also similar to the installation described in reference to FIG. 6, having rolled ends 136, 138 and first and second links 118, 120 replaced by spacing sleeves 134 and first and second flange members 122, 124 respectively.

Use of a predetermined range of torque values also permits all of the components of rear suspension system 24 to be sub-assembled and/or connected to frame 14 prior to applying the desired torque. This permits a “loose assembly” of components and therefore some reorientation as necessary as the various components are added to the suspension system. Variations between suspension systems due to variations in frame geometry, part variability, installation tolerances, and the like can therefore be accommodated and wheel alignment maintained before the fasteners of the sub-assembled suspension system are torqued.

Metal-to-metal contact connections are established during installation of all the fasteners of the present disclosure. A torque value selected from a predetermined torque range for all the fasteners of the present disclosure can therefore be used. In some embodiments, this torque range is between and inclusive of 20 to 25 lb-ft (27.12 to 33.89 Nm), however the disclosure is not limited to this range, and either lower or higher torque values can be used. In addition, the same engagement size for each fastener head or nut is also selected for all fasteners and nuts of the present disclosure. According to several embodiments, a 15 mm fastener head and nut size is selected, however the disclosure is not limited to this size. By using a standard torque range and common fastener head and nut engagement sizes, all the fasteners of the present disclosure can be installed with the same installation tool, reducing the possibility of installing any fastener or nut to an insufficient torque, over-torquing the fastener or nut and crushing the polymeric washers, or installing an incorrectly sized fastener or nut. Assembly time can therefore be reduced, thereby reducing assembly costs. Further, subsequent maintenance is also simplified as the mechanic does not have to change torque settings or stock multiple fastener sizes to remove or replace suspension components.

The description herein is merely exemplary in nature and, thus, variations that do not depart from the gist of that which is described are intended to be within the scope of the disclosure. Such variations are not to be regarded as a departure from the spirit and scope of the disclosure.

What is claimed is:

1. A method for standardizing fastener installation for a golf car suspension system, the suspension system having a leaf spring, a shock absorber having both a connecting sleeve and an extension sleeve positioned within the connecting sleeve, and a support plate, the method comprising:
configuring each of a plurality of suspension system component connections as one of a plurality of metal-to-metal contact connections;
selecting a single fastener engagement size for each of a plurality of fasteners used to couple the plurality of component connections;
applying a single predetermined torque to all of the plurality of fasteners, the predetermined torque selected from a predetermined range of torque values; and
installing each of the plurality of fasteners using a single installation tool operable to apply the predetermined torque and to engage the single fastener engagement size.

2. The method of claim 1, further comprising creating a first one of the metal-to-metal contact connections by:
sliding a first fastener defining a shoulder bolt having a starting thread position through a first rolled end of the leaf spring; and
connecting a second fastener defining a first nut into engagement with the starting thread position.

3. The method of claim 2, further comprising creating a second one of the metal-to-metal contact connections by:
positioning a third fastener defining a bolt with a bolt shaft inserted through the extension sleeve until a bolt engagement face of the bolt contacts a first end of the extension sleeve; and
engaging a second end of the extension sleeve with a frame member.

4. The method of claim 3, further comprising creating a third one of the metal-to-metal contact connections by fastening a second nut to a U-shaped bolt, the second nut being in contact with the support plate.

5. The method of claim 1, further comprising creating a fourth one of the metal-to-metal contact connections by:
positioning a fourth fastener defining a second bolt with a bolt shaft inserted through a second extension sleeve until a bolt engagement face of the bolt contacts a first end of the second extension sleeve; and
engaging a second end of the second extension sleeve with an axle housing connection member.

6. The method of claim 1, further comprising selecting a 15 mm fastener size for each of the plurality of fasteners.

7. The method of claim 1, further comprising defining the predetermined range of torque values between 20 to 25 lb-ft inclusive.

8. A method for standardizing fastener installation for a golf car suspension system, the suspension system including a leaf spring and a shock absorber, the method comprising:
configuring each of a plurality of suspension system component connections as one of a plurality of metal-to-metal contact connections;
selecting a single fastener engagement size for each of a plurality of fasteners used to couple the plurality of component connections;
sub-assembling the plurality of suspension system component connections prior to torquing any of the plurality of fasteners; and
applying a single predetermined torque value to each of the plurality of fasteners, the predetermined torque value selected from a range of torque values.

9. The method of claim 8, further comprising installing each of the plurality of fasteners using a single installation tool operable to apply the predetermined torque value and to engage the single fastener engagement size.

10. The method of claim 8, further comprising selecting a 15 mm fastener size for each of the plurality of fasteners.

11. The method of claim 8, further comprising defining the range of torque values between 20 to 25 lb-ft inclusive.

12. The method of claim 8, further comprising sliding a first fastener defining a shoulder bolt having a starting thread position through a rolled end of the leaf spring.

13. The method of claim 8, further comprising connecting a second fastener defining a first nut into engagement with the starting thread position to operably define a first metal-to-metal contact connection.

14. The method of claim 8, further comprising:
positioning a third fastener defining a bolt with a bolt shaft inserted through an extension sleeve until a bolt engagement face of the bolt contacts a first end of the extension sleeve; and
engaging a second end of the extension sleeve with a frame member to operably create a second metal-to-metal contact connection.

15. A method for assembling a golf car suspension system, the suspension system having a shoulder bolt having a bolt head, a bolt having a bolt shaft, a leaf spring having a rolled end, a leaf spring link assembly, a shock absorber having a connecting sleeve and an extension sleeve positioned within the connecting sleeve, and a support plate, the method comprising:
installing a plurality of fasteners to operably assemble the golf car suspension system, including:
sliding a first fastener defining the shoulder bolt having a starting thread position through the rolled end of the leaf spring;
connecting a second fastener defining a first nut into engagement with the starting thread position to operably define a first metal-to-metal contact connection; and
positioning a third fastener defining the bolt with the bolt shaft inserted through the extension sleeve until a bolt engagement face of the bolt contacts a first end of the extension sleeve;
engaging a second end of the extension sleeve with a frame member to operably create a second metal-to-metal contact connection; and
applying a torque having a single torque value to each of the plurality of fasteners.

16. The method of claim 15, further comprising fastening a second nut to a U-shaped bolt, the second nut being in contact with the support plate to operably create a third metal-to-metal contact connection.

17. The method of claim 16, further comprising selecting a single fastener engagement size for each of the first and second nuts and the bolt head.

18. The method of claim 17, further comprising installing each of the plurality of fasteners using a single installation tool having an engagement socket adapted to engage the single fastener engagement size.

19. The method of claim 15, further comprising positioning the rolled end of the leaf spring between an opposed pair of links of the link assembly prior to the sliding step.

20. The method of claim 15, further comprising threadably engaging a third nut to a threaded end of the bolt shaft extending beyond the frame member.

21. The method of claim 15, further comprising selecting the single torque value from a torque range defining 20 to 25 lb-ft inclusive.
